(19) United States
(12) Patent Application Publication
(10) Pub. No.: US 2003/0154201 A1
(43) Pub. Date: Aug. 14, 2003

(54) Data storage format for topography data

(75) Inventor: Alexander Leonidovich Berestov, San Jose, CA (US)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/073,306

(22) Filed: Feb. 13, 2002

(51) Int. Cl. G06F 7/00

(52) U.S. Cl. 707/100

(57) ABSTRACT

Data storage format for storing topography data associated with an object includes a first section for storing topography data in relation to a reference entity with respect to which the topography data is measured or calculated, a second section for storing information concerning the reference entity, and a third section for storing information concerning the topography direction along which the topography data is measured or calculated. Data is stored in the data storage format by determining reference entity with respect to which the topography data is measured or calculated, obtaining information regarding the reference entity and storing that information in a second section of the data storage format, obtaining information corresponding to the topography direction along which the topography data is measured or calculated and storing that information in a third section of the data storage format, and storing topography data in a first section of the data storage format. Data stored in the data storage format is utilized for registering and fusing topography data to other data.

### BACKGROUND OF THE INVENTION

1. Field of the Invention

The present invention relates to storage formats for image data and in particular to storage of topography data in a file format that allows efficient fusion and registration of topography data to other image data.

2. Description of the Related Art

A variety of data structures exist for storage of topography data. One is the regular grid structure, in which elevation data is stored at regular intervals in both X and Y topography directions, thus forming a regular lattice of points. The fixed grid spacing feature of this data structure allows the XY spatial coordinates for a point to be implied directly from its coordinates in the grid. Therefore the X and Y coordinates of each point on the grid need not be stored in the data structure, as long as the coordinates of the origin and the grid spacing are known.

Another popular format for storage of topography data is a triangulated irregular network (TIN), which stores slope and edge information for irregularly spaced points. A TIN is a form of a tesseral model based on triangles whose vertices form irregularly spaced nodes. Unlike the grid, the TIN allows storage of dense information in complex areas, and storage of sparse information in simpler or more homogeneous areas. The TIN data set includes topological relationships between points and their neighboring triangles. Each sample point has an X,Y coordinate and a surface, or Z-value. These points are connected by edges to form a set of non-overlapping triangles used to represent the surface. This irregular tessellation offers a way of incorporating both point and vector data representing surface points and features.

In the medical field, there are a variety of data analysis problems that involve registration and fusion of images of different dimensions in which information regarding frame of reference for each image is required. Registration refers to proper alignment of multiple, superimposed data, such as image data. Images that are not correctly aligned are said to be out of register. Fusion refers to combination or union of data. In the case of image data, for example, fusion refers to the combination of different images into overlapping images.

Topography data, as a special category of image data, may originate from different acquisition devices or be created in order to simplify or improve the analysis. An example is a two-dimensional topography map of the retina, which is acquired by a scanning laser tomograph. Similarly, topography data may be obtained from two-dimensional stereo images of the retina by performing matching analysis. Another example is the topography of a human face acquired by non-contact digitizing scanner.

A capability to register and fuse topography data to other image data is particularly desirable in the medical field where data such as computerized tomography (CT) scan data, ultrasound image data, x-ray image data, infrared image data, and photographic data pertaining to the same patient are routinely collected and analyzed. Each of these imaging techniques may reveal different features or aspects of a medical condition. It is often desirable to combine or overlap topography images onto other images in order to compare and contrast aspects of the different data sets at particular locations in the object, to form fused three-dimensional images from the combined data sets, and to manipulate the data sets in a variety of different ways.

One example is a CT scanner that acquires a volumetric data set of a human skull. The CT system packages the image data and exports it. A workstation application performs a process to segment acquired image data into bone volume. Another image capture device, a Laser Range Scanner, obtains preoperative topography of the patient's face and also exports it. A workstation application performs fusion of two data sets, and the resulting fused data are used for 3-D simulation of craniofacial surgical procedures.

Another example is an ultrasound system, which samples a three-dimensional view of the eye and orbit and generates a volumetric image of the retina with membranes, coronal and saggital view. The ultrasound system exports this to a workstation. A Fundus camera obtains a stereo image pair of the same retina and exports the pair of images with the location of focal points to the same workstation. A workstation application performs depth map reconstruction and retinal topography calculation, formats the data and packages them into a file for viewing, archive and future comparative analysis. Another workstation application performs fusion of ultrasound volume and topography data and the resulting fused data are used for location of retinal pathologies.

Although a single 2-D image does not usually contain third dimension information, in case of topography data, the image itself provides information regarding the third dimension. One problem is that this information is usually obtained in relationship with some reference surface or even a single point in space, and it is necessary to know what this surface represents and where it is located in order to interpret topography data correctly. Another problem is lack of a uniform approach to handling spatial relationship between topography data and 3D volumes.

### SUMMARY OF THE INVENTION

The present invention addresses the foregoing needs and provides for storage of topography data in a format that allows for registration and fusion of topography data with other types of data.

In one aspect, the invention is a data storage format for topography data in relation to a reference entity with respect to which the topography data is measured or calculated. The reference entity may be a point, a line, a surface, a volume, another topographyal surface, or a surface that can be described as an N-dimensional function.

According to the data storage format, information concerning the location of the reference entity, with respect to which topography data is measured or calculated, is also stored. In addition, the data storage format stores information regarding the topography directional vector in which topography direction topography data is measured or calculated.

The topography data, the information concerning location of the reference entity with respect to which topography data is measured or calculated, and the topography directional vector along which topography data is measured or calculated, are stored in N-dimensional space, that includes three spatial coordinates and additional coordinates such as time, energy, etc., in order to facilitate matching the topography data to other image data stored in N-dimensional space.

An advantage of the inventive data storage format is determination of topography data with respect to a two-dimensional reference entity whose coordinates are also stored, and storage of the direction along which topography data are measured or calculated. The inventive data storage format thus allows for registration and fusion of topography data to other image data. In addition, the inventive data storage format provides for consideration of topography data sets in non-Cartesian coordinate systems and for using topography data itself as a reference entity for other topography surfaces.

This brief summary has been provided so that the nature of the invention may be understood quickly. A more complete understanding of the invention can be obtained by reference to the following detailed description of the preferred embodiment(s) thereof in connection with the attached drawings.

### BRIEF DESCRIPTION OF THE DRAWINGS

FIG. 1 is a view illustrating the outward appearance of a representative embodiment of the present invention.

FIG. 2 is a detailed block diagram of the computing equipment shown in FIG. 1.

FIG. 3 shows a representative object whose topography is being measured or calculated, a reference entity with respect to which the topography is being measured or calculated, and a topography directional vector in which topography direction the topography is obtained.

FIG. 4 is a diagram showing a transformation between two coordinate systems, each of which correspond to a different system for acquiring an image.

FIG. 5 is a functional block diagram showing the content of the data storage format of the present invention.

FIG. 6 is a flow diagram showing the steps involved in creating a flow diagram in accordance with the present invention.

FIG. 7 is a flow diagram which provides an illustration for providing a preferred technique for utilizing the stored topography data in accordance with the present invention.

### DETAILED DESCRIPTION OF THE PREFERRED EMBODIMENTS

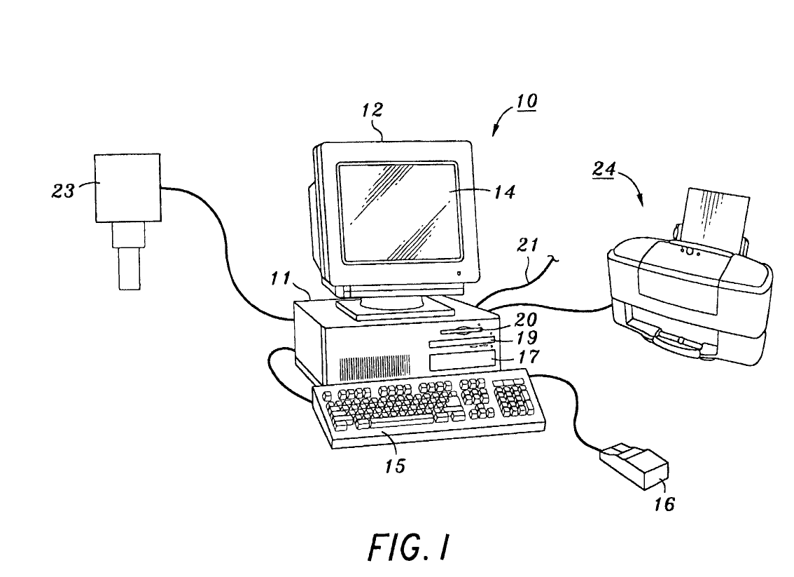

FIG. 1 is a view showing the outward appearance of a representative embodiment of the invention. Computing equipment 10 includes host processor 11 comprising a workstation that is typically used by a hospital or other diagnostic facilities for image processing and other applications. The workstation preferably has a windowing operating system such as Microsoft Windows, Xwindows or MacIntosh operating systems. Provided with the computing equipment 10 are color monitor 12 including display screen 14, keyboard 15 for entering text data and user commands, and pointing device 16. Pointing device 16 preferably comprises a mouse, for pointing, selecting and manipulating objects displayed on display screen 14.

Computing equipment 10 includes a computer-readable memory medium such as a fixed disk 17 and/or floppy disk drive 19 and/or CD-ROM drive 20. Such computer readable memory media allow computing equipment 10 to access information such as image data, computer executable process steps, application programs, and the like, stored on removable and non-removable memory media. In addition, network access 21 allows computing equipment 10 to acquire information, application programs such as application programs that perform fusion of two data sets and topography calculation, and image data such as computerized tomography (CT) scan data, ultrasound image data, x-ray image data, infrared image data, and photographic data from other sources, such as a hospital's local area network or the Internet, for example.

Image capture device 23 is preferably an imaging device that is typically used by a hospital or other diagnostic facilities, such as CT scanner, ultrasound imaging system, laser scanner and magnetic resonance imager. Image capture device 23 captures topography and other images and transmits the image data to computing equipment 10. Printer 24 is a color output device such as an ink jet printer or a color laser beam printer, for example.

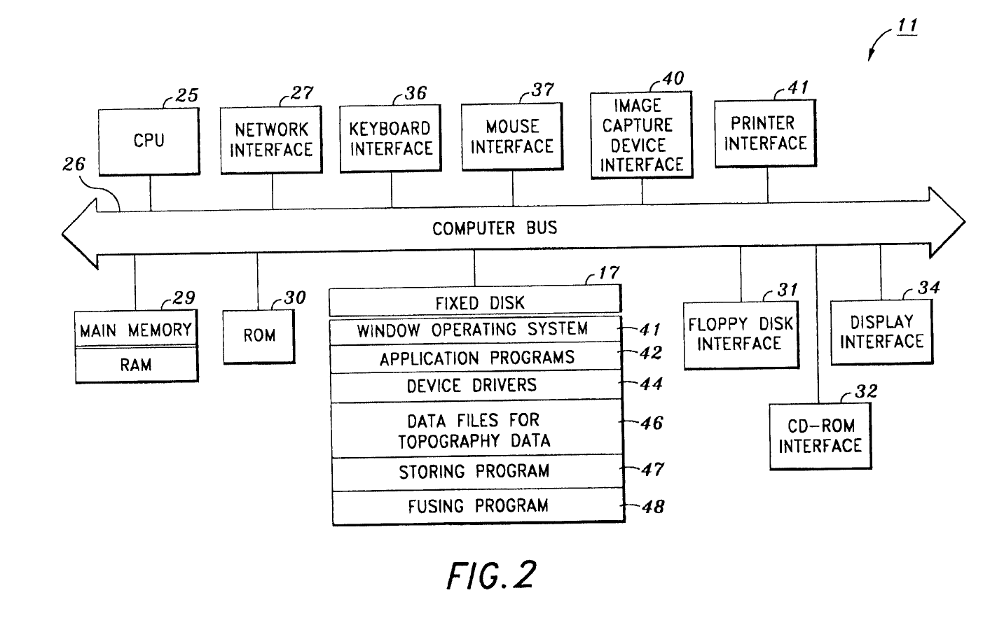

FIG. 2 is a detailed block diagram showing the internal architecture of workstation 11. As shown in FIG. 2, workstation 11 includes central processing unit (“CPU”) 25 that interfaces with computer bus 26. Also interfacing with computer bus 26 are fixed disk 17, network interface 27 for network access 21, random access memory (“RAM”) 29 for use as main memory, read only memory (“ROM”) 30, floppy disk interface 31, CD-ROM interface 32, display interface 34 to monitor 12, keyboard interface 36 to keyboard 15, mouse interface 37 to pointing device 16, image capture device interface 40 to image capture device 23, and printer interface 41 to printer 24.

Main memory 29 interfaces with computer bus 26 so as to provide RAM storage to CPU 25 during execution of software programs such as the operating system, application programs, and device drivers. More specifically, CPU 25 loads computer-executable process steps from disk 17 or other memory media into a region of main memory 29, and thereafter executes the stored process steps from main memory 29 in order to execute software programs. Data such as image data can be stored in main memory 29, where it can be accessed by CPU 25 during execution.

As also shown in FIG. 2, fixed disk 17 contains a windowing operating system 41, application programs 42 such as application programs that manipulate, obtain and print images captured by image capture device 23, data files for topography data 46, program for formatting and saving data in data files 47, and program for fusing images 48 including fusing topography data contained in the data files to other image data.

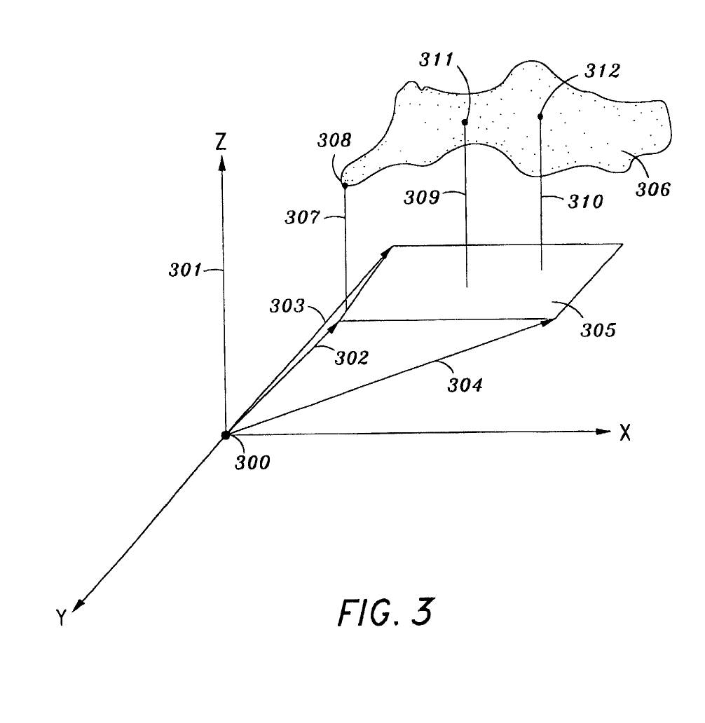

FIG. 3 shows a representative object whose topography is being measured or calculated, a reference entity with respect to which the topography is being measured or calculated, and a topography directional vector in which topography direction the topography is obtained. Preferably, the topography of object 306 is determined in a global coordinate system that is preferably a Cartesian system where the coordinates of a point are its distances from a set of three perpendicular lines in space that intersect at an origin 300. However, the global coordinate system in which topography of object 306 is determined, can be any coordinate system such as spherical, cylindrical, etc., and generally N-dimensional.

Object 306 whose topography is subject to determination is preferably a surface associated with a human body such as a human face or a human retina. Although the object 306 is preferably a surface associated with a human body, it can also be a surface that is associated with any other object whose topography is capable of being determined.

Reference entity 305 is entity with respect to which the topography of object 306 is being determined. Reference entity 305 is preferably a two-dimensional X-Y plane, but can also be a point, a line, another topography surface, or any other reference with respect to which topography of surface 306 can be measured or calculated and in another coordinate sytem. The position of the reference entity 305 with respect to the global coordinated system 300 is preferably determined by coordinates a corner of the reference entity identified by reference number 303, and two axes identified by reference numbers 303 and 304 along which topography of object is determined. However, the location of the reference entity 305 with respect to the global coordinate system may also be determined by three points positioned on the reference entity that are not positioned along the same line, and the location of axes along which topography data is measured or calculated. This latter approach is not as efficient as it requires storage of coordinates identifying the axes.

Elevation data in topography are measured or calculated with respect to a reference surface. They are therefore a function of direction along which the measurement or calculation is being obtained. In FIG. 3 topography direction along which topography data for the object 306 is determined is identified by the reference number 301. The topography direction is preferably in a direction perpendicular to the X-Y axes along which topography data is determined, but could also be any other direction. Elevation of points 308 located on object 306 are measured along this topography direction 301.

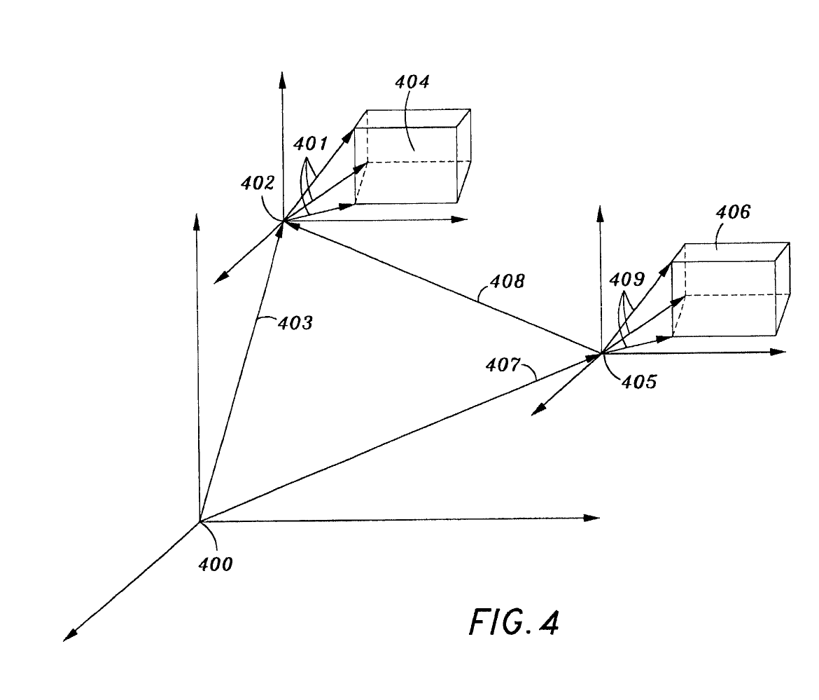

FIG. 4 is a diagram showing a transformation between two coordinate systems, each of which corresponds to a different image. Briefly, FIG. 4 shows a three-dimensional image of an object and a topographyal image of the same object. Each of these images are measured with respect to a local coordinate system that is independent of the other coordinate system. By knowing the position of each of the local coordinate systems with respect to a global coordinate system, a transformation between the two independent frames of reference corresponding to the two images can be performed.

In more detail, reference number 404 represents a three dimensional volumetric image of a retina that is preferably generated by an Ultrasound system that forms an image of an object by emitting an ultrasound wave toward the object and detecting wave that is reflected from the object. However, the three dimensional volumetric image can also be generated by a different imaging device. Reference number 401 represents the location of three points on the reference number 404 that fix the location of the image in a first local coordinate system. Reference number 403 shows the position of the first local coordinate system with respect to global coordinate system 400.

The global coordinate system is preferably a right handed Cartesian coordinate system whose origin 400 is located inside patient's body and whose Z axis is in a topography direction pointing outward from the patient's head. The global coordinate system can also be any other coordinate system that is capable of being used to assign the coordinates of all points relative to a single common origin such as a Polar or Spherical coordinate system.

Reference number 406 represents a topography image of the same retina that is obtained by an application that performs depth map reconstruction and retinal topography calculation on a stereo image of the retina obtained by image capture device 23. Reference number 409 represents the location of three points on the reference number 404 that fix the location of the image in a second local coordinate system. Reference number 407 shows the position of the second local coordinate system with respect to the global coordinate system 400.

Reference number 408 represents the relative position of the first local coordinate system 403 relative to that of the second coordinate system 405, in the global coordinate system 400. Knowledge of this relative position between the two coordinate systems makes it possible to perform a transformation between the two coordinate systems in order to fuse the three dimensional volumetric image 404 to the topography image 406.

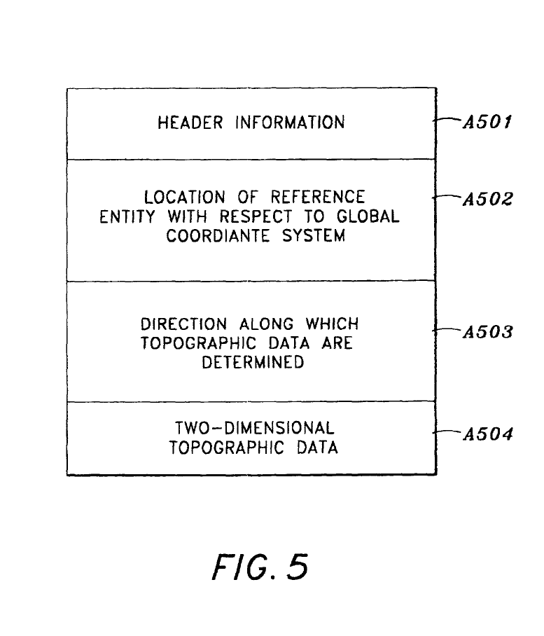

FIG. 5 is a functional block diagram showing the content of the data storage format of the present invention. Briefly, the inventive data storage format contains header information, information regarding location of the reference entity in a global coordinate system, information identifying topography direction along which topography data are measured or calculated, and elevation data.

In more detail, the data storage format contains header information is stored in area A501. Preferably, header area includes the following information:

a) number of topography data sets that are present in the inventive data storage format, with each topography data set corresponding to a different surface;

b) an identifier label such as an alphanumeric code that is used for uniquely identifying a topography data set from other topography sets;

c) a detailed text description of the topography data that explains and describes the data, such as patient's name and body area which the topography data represents;

d) an abbreviated text description that can be used for purpose of display or annotation of the topography data;

e) an object identifier which identifies the object, such as a retina, to which the topography data belongs;

f) information regarding size of the topography array, such as a two-valued attribute, one value per axis, that specifies a maximum index value.

Area A502 of the data storage format contains information regarding location of the reference entity 305 with respect to which topography of object 306 is obtained. The location of the reference entity is uniquely determined by points that are positioned on surface of the reference entity and are not located on a same line. Reference number 302 is a vector that describes location of a corner of the reference entity with respect to the global reference system. Reference number 303 and 304 respectively identify directions along which topography data is sampled. Coordinates for vectors corresponding to reference numbers 302, 303 and 304 are stored in a area A502 on the inventive data storage format.

The inventive data storage format contains information that uniquely identifies topography direction 301 along which topography of object 306 with respect to reference entity 305 is measured or calculated. Topography of object 306 with respect to the reference entity 305 is a function of the topography direction along which the topography data are measured or calculated. Information regarding the topography direction 301 is therefore needed in order to be able to accurately interpret the topography data. Information concerning the topography direction 301 is stored in area A503 of the inventive data storage format.

Area A504 of the data storage format contains topography data for object 306 that are determined in relation to the reference entity 305 along the topography direction 301. This data consists of elevation values for points located on surface of the object with respect to the reference entity 305 along the topography direction 301. Reference number 308 corresponds to a vector that corresponds to elevation of point 308 positioned on surface of object 306 with respect to the reference entity 305 along the topography direction 301. The topography data structure is preferably a regular or fixed grid structure in which points are stored in two (X and Y) dimensions, thus forming a regular lattice of points. Each elevation is stored as an element in a two dimensional matrix or array such that a search for a point may be implied directly from its coordinates. This relationship between coordinates and matrix position means that X and Y coordinates of each point need not be stored in the data storage format, so long as coordinates of the origin and grid spacing are known.

Although the topography data structure is preferably a regular grid, it can also be any other topography data structure where elevation of a point can be represented as a function of X and Y coordinates.

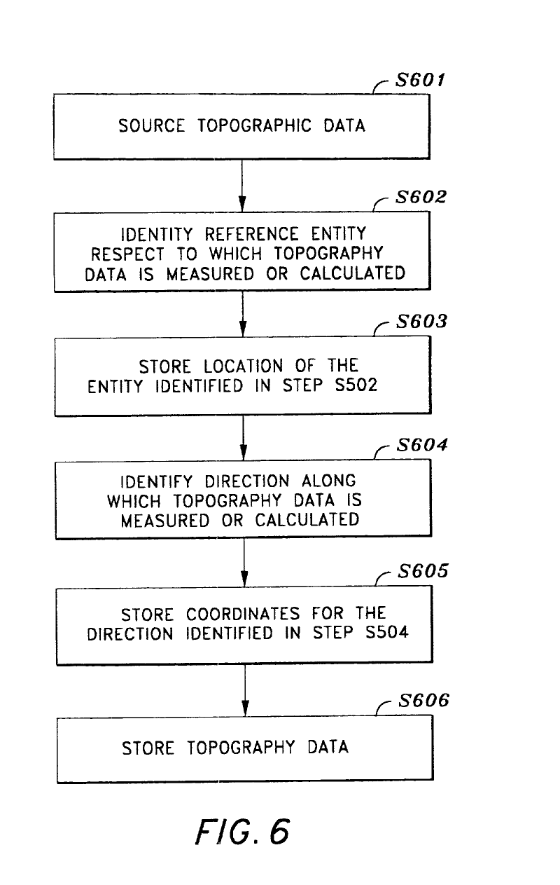

FIG. 6 is a flow diagram showing the steps involved in creating the inventive data storage format in accordance with the present invention. Source topography data of step S601 is topography data that is preferably originated from an acquisition device such as a Scanning Laser Tomograph device. However, source topography data may also be created by an application on computing device 10 in order to simplify or improve analysis.

In step S602 the reference entity 305, with respect to which topography data is measured or calculated, is identified. The reference entity is typically housed inside the image capture device that acquires topography image, or obtains image(s) on which basis topography data is calculated. For example, in case of the Scanning Laser Tomograph image capture device, topography is determined with respect to a laser sensor that is located inside the device.

In step S603 location of the reference entity 305 identified in step S602, with respect to which topography data is measured or calculated, is stored. This step preferably includes storage of coordinates of a corner 308 of the two dimensional reference entity 305 and storage of coordinates for axes along which object 306 topography is sampled.

In step S604, the topography direction 301, along which topography data is measured or calculated, is identified. Topography data, are measured or calculated along this direction 301. The location of the topography direction 301 is stored in step S605.

The topography data is stored per step S606. Here, the topography data corresponds to the elevation of points located on surface of object 306 with respect to the reference entity 305. Preferably, a regular grid data structure is used for storage of topography data, in which elevation data is stored at regular intervals in both X and Y topography directions, thus forming a regular lattice of points. The fixed grid spacing feature of this data structure allows the search for a point to be implied directly from its coordinates. Therefore the X and Y coordinates of each point on the grid need not be stored in the data structure, as long as the coordinates of the origin and the grid spacing are known. However, any other two dimensional array can also be used to store topography data.

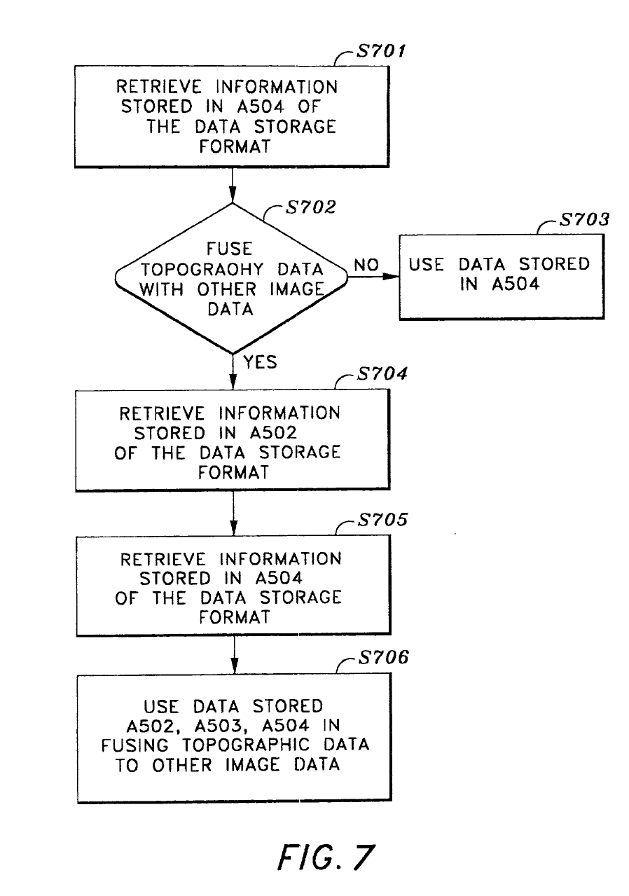

FIG. 7 is a flow diagram which provides an illustration for a preferred technique for utilizing the stored topography data in accordance with the present invention. In step S701 information stored in area A504 of the data storage format, which corresponds to the topography data for the object 306 with respect to the reference entity 305 and measured in the topography direction 307, is retrieved.

In step S702 an inquiry is made as to whether the topography data is to be used in connection with fusing of topography image, to which data retrieved in step S701 corresponds, to another image. A negative response to the step S702 inquiry means that the only data that need be used is the elevation data stored in area A504 of the data storage format and retrieved in step S701 above.

An affirmative response to the inquiry in step S702 means a frame of reference transformation between two data sets having independent frames of reference needs to be computed in order to fuse images.

In step S704 information stored in area A503 of the data storage format, corresponding to the location of the reference entity 305 with respect to which topography data is measured or calculated, is retrieved. In step S705, information stored in area A504 of the data storage format, corresponding to the location of the topography direction 301 with respect to which the topography data is measured or calculated, is retrieved.

Data retrieved in steps S704, S705, and S706 are used to register or otherwise fuse the topography image to other images.

While the invention is described above with respect to what is currently considered its preferred embodiment, it is to be understood that the invention is not limited to that described above. To the contrary, the invention is intended to cover various modifications and equivalent arrangements within the spirit and scope of the appended claims.

What is claimed is:

1. Data storage format for storing topography data associated with an object comprising:
a first section for storing topography data in relation to a reference entity with respect to which the topography data is determined;
a second section for storing information concerning the reference entity;
a third section for storing information concerning the topography direction along which the topography data is measured or calculated.

2. The data storage format described in claim 1, wherein the topography data is defined in N-dimensional space.

3. The data storage format described in claim 1, wherein the information concerning the reference entity is defined in N-dimensional space.

4. The data storage format described in claim 1, wherein the reference entity is another topography surface.

5. The data storage format described in claim 1, wherein the reference entity is described as a function in N-dimensional space.

6. The data storage format described in claim 1, wherein the reference entity is a point in space.

7. The data storage format described in claim 1, wherein the reference entity is a line.

8. The data storage format described in claim 1, wherein the topography data, the reference entity, and the topography direction are described in a Cartesian coordinate system.

9. The data storage format described in claim 1, wherein the topography data, the reference entity, and the topography direction are described in a non-Cartesian coordinate system.

10. The data storage format described in claim 1, wherein position of the reference entity and the topography direction with respect to a global coordinate system are known.

11. The data storage format described in claim 10, wherein the global coordinate system is one that has its origin in a patient's body.

12. The data storage format described in claim 10, wherein the reference entity and the topography direction are registered with respect to a first coordinate system, the first coordinate system being registered to the global coordinated system.

13. The data storage format described in claim 12, wherein a transformation is performed between the first coordinate system and a second coordinate system to which a three dimensional image is registered, the second coordinate system being independent from the first coordinate system and being registered to the global coordinate system.

14. The data storage format described in claim 13, wherein the three dimensional image is fused to the topography data.

15. Method for storing topography data in data storage format comprising;
storing topography data in a first section of the data storage format,
determining reference entity with respect to which the topography data is measured or calculated and storing the information in a second section of the data storage format;
obtaining information regarding the topography direction along which the topography data is measured or calculated and storing the information in a third section of the data storage format.

16. Method for using data stored in data storage format including a first section for storing topography data, a second section for storing information concerning reference entity with respect to which the topography data is determined, and a third section for storing information concerning topography direction along which the topography data is measured or calculated, comprising:
utilizing the topography data stored in a first section of the data storage format for applications that do not involve fusion of the topography data to other image data;
utilizing information stored in all three sections of the data storage format in connection with applications that involve fusion of the topography data to other image data.

17. The method described in claim 16, wherein data stored in a first section of the data storage format is used to register and fuse the topography data to a three-dimensional image.
